(19) United States
(12) Patent Application Publication
(10) Pub. No.: US 2012/0226899 A1
(43) Pub. Date: Sep. 6, 2012

(54) METHOD AND APPARATUS FOR ADAPTING SETTINGS FOR REQUESTING CONTENT SEGMENTS BASED ON CONTEXTUAL CHARACTERISTICS

(75) Inventor: Sailesh Sathish, Tampere (FI)

(73) Assignee: Nokia Corporation

(21) Appl. No.: 13/038,856

(22) Filed: Mar. 2, 2011

(51) Int. Cl. G06F 9/00

(52) U.S. Cl. 713/100

(57) ABSTRACT

An apparatus may include a registrar configured to register settings for requesting content segments. The settings may be configured to apply to requests for content segments from all of the content providers of a content channel or one or more individual content providers. A contextual characteristic determiner may be configured to determine contextual characteristics of the user and/or the apparatus. A settings manager may be configured to adapt the settings based on the contextual characteristics determined by the contextual characteristic determiner. Thereby, update settings, operational settings, and/or other settings may be adapted. Further, a content requestor may be configured to build a content request package based on the settings. Accordingly, content providers and/or a content recommender may recommend content based on the content request package.

### TECHNOLOGICAL FIELD

An example embodiment of the present invention relates generally to techniques for adapting settings for requesting content segments and, more particularly, relates to an apparatus, a method and a computer program product for adapting settings for requesting content segments based on contextual characteristics.

### BACKGROUND

In order to provide easier or faster information transfer and convenience, telecommunication industry service providers are continually developing improvements to existing communication networks. As a result, wireless communication has become increasingly more reliable in recent years. Along with the expansion and improvement of wireless communication networks, mobile terminals used for wireless communication have also been continually improving. In this regard, due at least in part to reductions in size and cost, along with improvements in battery life and computing capacity, mobile terminals have become more capable, easier to use, and cheaper to obtain. Due to the now ubiquitous nature of mobile terminals, people of all ages and education levels may utilize mobile terminals to communicate with other individuals or contacts, receive services and/or share information, media and other content.

Some of the technologies which are becoming more popular are those of location based services and other personalized services. In this regard, some technologies may provide users of properly equipped mobile terminals with content that is specific to the present location of the user. Thus, for example, the user may be provided with weather information relating to the user's present location. Thereby, content may be provided to the user which may be relevant to the user's interests and current context. However, it may still be possible to improve the provision of content to users.

### BRIEF SUMMARY

A method, apparatus and computer program product are therefore provided that may adapt settings for recommendation of content segments based on contextual characteristics.

In an example embodiment, an apparatus comprises at least one processor and at least one memory including computer program code, the at least one memory and the computer program code configured to, with the processor, cause the apparatus to register one or more settings for requesting one or more content segments. Further, the apparatus may determine at least one contextual characteristic and adapt the settings based on the contextual characteristic. Also, the apparatus may build a content request package based on the settings.

In an additional example embodiment a method comprises registering one or more settings for requesting one or more content segments. The method may also comprise determining at least one contextual characteristic and adapting the settings via a processor based on the contextual characteristic. Further, the method may include building a content request package based on the settings.

In a further example embodiment a computer program product comprises at least one computer-readable storage medium having computer-executable program code portions stored therein, the computer-executable program code portions comprising program code instructions for registering one or more settings for requesting one or more content segments. The computer program product may further comprise program code instructions for determining at least one contextual characteristic and program code instructions for adapting the settings based on the contextual characteristic. Also, the computer program product may include program code instructions for building a content request package based on the settings.

In a further example embodiment an apparatus comprises means for registering one or more settings for requesting one or more content segments. The apparatus may also comprise means for determining at least one contextual characteristic and means for adapting the settings based on the contextual characteristic. Further, the apparatus may include means for building a content request package based on the settings.

In some embodiments the settings may comprise one or more update settings and/or one or more operational settings. A mode of transportation may be determined, and the settings may be adapted based on the mode of transportation. Update settings may be adapted based on a spatial interval in an instance in which the mode of transportation is a walking mode. Further, update settings may be adapted based on a temporal interval in an instance in which the mode of transportation is a non-walking mode. The settings may be registered for a content channel configured to recommend the content segments.

User interface circuitry may also be provided which is configured to facilitate user control of at least some functions through use of a display. The user interface circuitry may cause at least a portion of a user interface to be displayed on the display to facilitate user control of at least some functions. Accordingly, embodiments of the present invention may provide a way to adapt settings for requesting content segments from content providers and/or content recommenders. Thereby, the data included in the requests and the intervals at which the requests are sent may be varied based on the contextual characteristics of the user and/or the apparatus. Thus, efficiencies in terms of reduced computations, battery usage, and/or bandwidth usage may be achieved by limiting the data sent in the request to that which is relevant to the contextual characteristics of the user.

### BRIEF DESCRIPTION OF THE SEVERAL VIEWS OF THE DRAWING(S)

Having thus described embodiments of the present disclosure in general terms, reference will now be made to the accompanying drawings, which are not necessarily drawn to scale, and wherein:

FIG. 1 illustrates a schematic block diagram of a system according to an example embodiment of the present invention;

FIG. 2 illustrates a schematic block diagram of an apparatus configured to adapt settings for requesting content segments based on contextual characteristics according to an example embodiment of the present invention;

FIG. 3 illustrates a schematic block diagram of an embodiment of the apparatus of FIG. 2 including additional components configured to adapt settings for requesting content segments based on contextual characteristics according to an example embodiment of the present invention; and

FIG. 4 illustrates a flowchart of the operations performed in adapting settings for requesting content segments based on contextual characteristics according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a computer-readable storage medium, which refers to a non-transitory, physical storage medium (e.g., volatile or non-volatile memory device), can be differentiated from a computer-readable transmission medium, which refers to an electromagnetic signal.

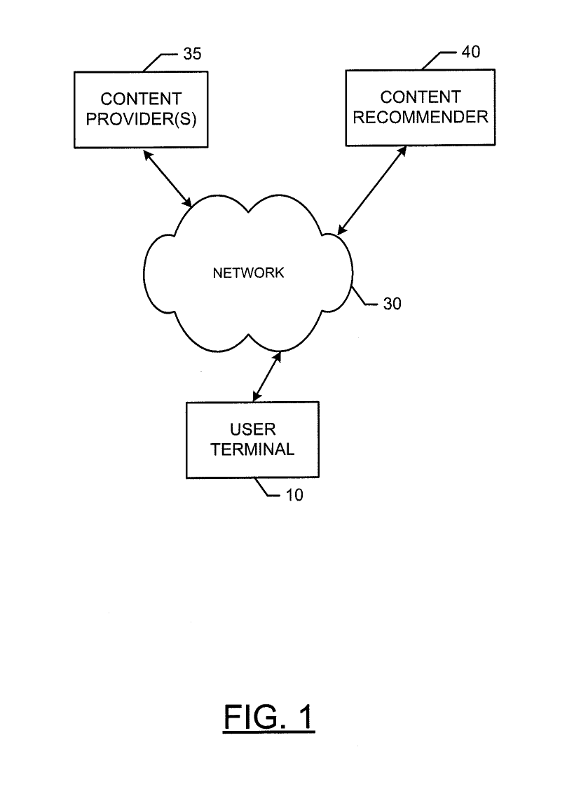

As indicated above, some embodiments of the present invention may be employed in methods, apparatuses and computer program products configured to adapt settings for requesting content segments based on contextual characteristics. In this regard, for example, FIG. 1 illustrates a block diagram of a system that may benefit from embodiments of the present invention. It should be understood, however, that the system as illustrated and hereinafter described is merely illustrative of one system that may benefit from an example embodiment of the present invention and, therefore, should not be taken to limit the scope of embodiments of the present invention.

As shown in FIG. 1, a system in accordance with an example embodiment of the present invention may include a user terminal 10. The user terminal 10 may be any of multiple types of fixed or mobile communication and/or computing devices such as, for example, personal digital assistants (PDAs), pagers, mobile televisions, mobile telephones, gaming devices, laptop computers, personal computers (PCs), cameras, camera phones, video recorders, audio/video players, radios, global positioning system (GPS) devices, or any combination of the aforementioned, which employ an embodiment of the present invention.

In some embodiments the user terminal 10 may be capable of communicating with other devices, either directly, or via a network 30. The network 30 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network 30. Although not necessary, in some embodiments, the network 30 may be capable of supporting communication in accordance with any one or more of a number of first-generation (1G), second-generation (2G), 2.5G, third-generation (3G), 3.5G, 3.9G, fourth-generation (4G) mobile communication protocols, Long Term Evolution (LTE), and/or the like. Thus, the network 30 may be a cellular network, a mobile network and/or a data network, such as a local area network (LAN), a metropolitan area network (MAN), and/or a wide area network (WAN), for example, the Internet. In turn, other devices such as processing elements (for example, personal computers, server computers or the like) may be included in or coupled to the network 30. By directly or indirectly connecting the user terminal 10 and the other devices to the network 30, the user terminal and/or the other devices may be enabled to communicate with each other, for example, according to numerous communication protocols including Hypertext Transfer Protocol (HTTP) and/or the like, to thereby carry out various communication or other functions of the user terminal and the other devices, respectively. As such, the user terminal 10 and the other devices may be enabled to communicate with the network 30 and/or each other by any of numerous different access mechanisms. For example, mobile access mechanisms such as wideband code division multiple access (W-CDMA), CDMA2000, global system for mobile communications (GSM), general packet radio service (GPRS) and/or the like may be supported as well as wireless access mechanisms such as wireless LAN (WLAN), Worldwide Interoperability for Microwave Access (WiMAX), WiFi, ultra-wide band (UWB), Wibree techniques and/or the like and fixed access mechanisms such as digital subscriber line (DSL), cable modems, Ethernet and/or the like. Thus, for example, the network 30 may be a home network or other network providing local connectivity.

The user terminal 10 may be configured to request, receive, and output Uniform Resource Locators (URLs), text, pictures, data, audio, video, and/or various other embodiments and media formats of content segments. In some embodiments the content may be provided to the user terminal 10 by one or more content providers 35. One or more of the content providers 35 may be embodied as a server, server bank or other computer or other computing device or node configured to provide content segments to the user terminal 10. Each of the content providers 35 may have any number of functions or associations with various services. As such, for example, one or more of the content providers 35 may be a platform such as a dedicated server (or server bank), or one or more of the content providers may be a backend server associated with one or more other functions or services. Thus, the content providers 35 may provide content to the user terminal 10 for use by a user thereof. A content provider may also be a service provider.

In some embodiments the system may further comprise a content recommender 40. In some embodiments the content recommender 40 may be embodied as a server, server bank or other computer or other computing device or node configured to recommend one or more content segments for the user of the terminal 10 based on a request therefrom. The content recommender 40 may have any number of functions or associations with various services. As such, for example, the content recommender 40 may be a platform such as a dedicated server (or server bank), or the content recommender may be a backend server associated with one or more other functions or services. In some embodiments, the content recommender 40 may also be part of the content providers 35. There may be several content recommenders 40 each provided by a respective service provider in some embodiments.

In some embodiments the system may provide for output of content segments recommended for a user by the content recommender 40 and provided by one or more content providers 35. In this regard, the user terminal 10 may build a content request package and send the request to the content recommender 40. The content recommender 40 may recommend content provided by the content providers 35 based on the content request package received from the user terminal 10. Thereby, the user terminal 10 may provide for output of the content segments recommended by the content recommender 40 and provided by the content providers 35.

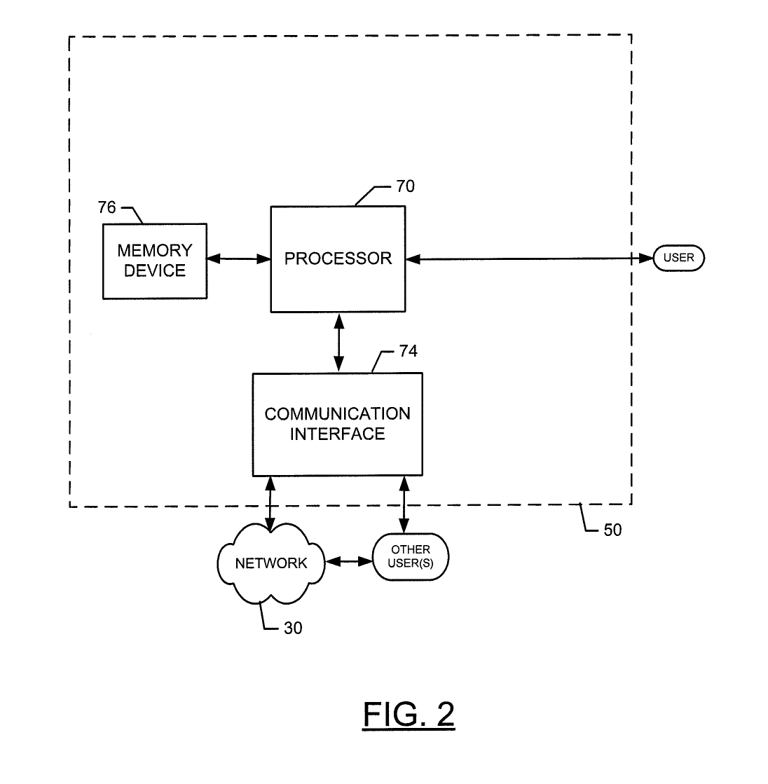

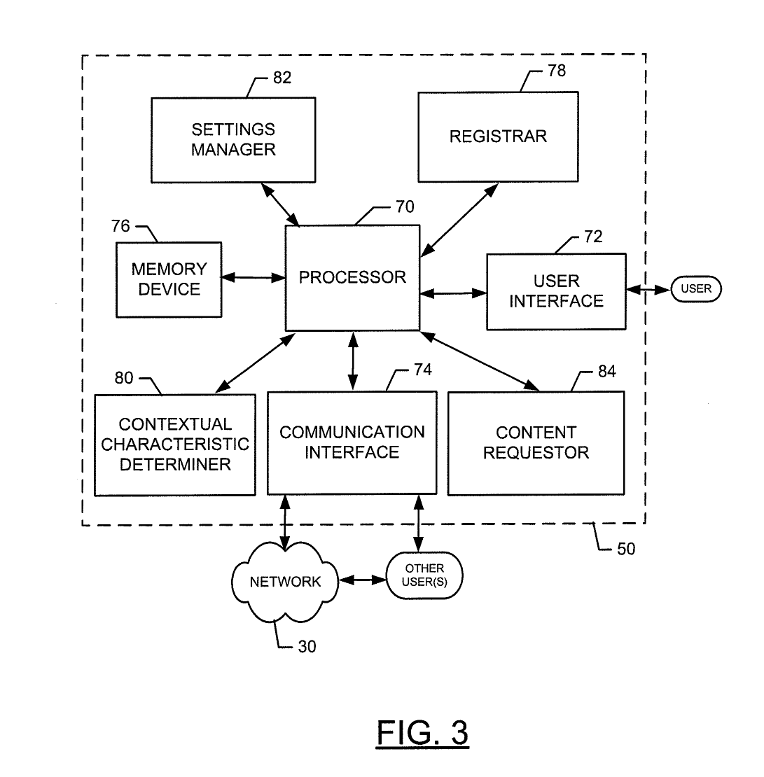

In example embodiments illustrated in FIGS. 2 and 3, an apparatus 50 is provided that may be employed by devices performing example embodiments of the present invention. The apparatus 50 may be embodied, for example, as any device hosting, including, controlling, comprising, or otherwise forming a portion of the user terminal 10, the content providers 35, and/or the content recommender 40. However, embodiments may also be embodied on a plurality of other devices such as for example where instances of the apparatus 50 may be embodied on the network 30. As such, embodiments of the apparatus 50 illustrated in FIGS. 2 and 3 are merely examples and may include more, or in some cases less, than the components shown in FIGS. 2 and 3.

With further regard to FIGS. 2 and 3, the apparatus 50 may be configured to provide for output of one or more content segments. As depicted in FIG. 2, the apparatus 50 may include or otherwise be in communication with a processor 70, a communication interface 74, and a memory device 76. The memory device 76 may include non-transitory and tangible memory that may be, for example, volatile and/or non-volatile memory. The memory device 76 may be configured to store information, data, files, applications, instructions or the like. For example, the memory device 76 could be configured to buffer input data for processing by the processor 70. Additionally or alternatively, the memory device 76 could be configured to store instructions for execution by the processor 70.

As mentioned above, the apparatus 50 may, in some embodiments, be a user terminal or a fixed communication device or computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 70 may be embodied in a number of different ways. For example, the processor 70 may be embodied as one or more of various processing means such as a coprocessor, a microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a hardware accelerator, a special-purpose computer chip, or other hardware processor. In an example embodiment, the processor 70 may be configured to execute instructions stored in the memory device 76 or otherwise accessible to the processor. Alternatively or additionally, the processor 70 may be configured to execute hard coded functionality. As such, whether configured by hardware or software methods, or by a combination thereof, the processor 70 may represent an entity (for example, physically embodied in circuitry) capable of performing operations according to embodiments of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor to perform the algorithms and/or operations described herein when the instructions are executed. However, in some cases, the processor 70 may be a processor of a specific device (for example, a user terminal or network device such as a server) adapted for employing embodiments of the present invention by further configuration of the processor by instructions for performing the algorithms and/or operations described herein. The processor 70 may include, among other things, a clock, an arithmetic logic unit (ALU) and logic gates configured to support operation of the processor.

The communication interface 74 may be any means such as a device or circuitry embodied in either hardware, software, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (for example, network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet, High-Definition Multimedia Interface (HDMI) or other mechanisms. Furthermore, the communication interface 74 may include hardware and/or software for supporting communication mechanisms such as BLUETOOTH®, Infrared, UWB, WiFi, and/or the like, which are being increasingly employed in connection with providing home connectivity solutions.

As mentioned above, embodiments of the apparatus 50 may include more, or in some cases less, than the components shown in FIG. 2. In this regard, FIG. 3 illustrates an embodiment of the apparatus 50 comprising additional components configured to adapt settings for requesting content segments based on contextual characteristics. The apparatus 50 may include or otherwise be in communication with the processor 70, the communication interface 74, and the memory device 76 as described above with respect to FIG. 2. Note that a module, as may be used herein, need not necessarily be modularized, but instead may be distributed in some embodiments. Thus, the term module is only used to designate the functions associated with or performed by the respective module, rather than any structure associated therewith.

In some embodiments the apparatus 50 may further comprise a user interface 72. The user interface 72 may be in communication with the processor 70 to receive an indication of a user input at the user interface and/or to provide an audible, visual, mechanical or other output to the user. As such, the user interface 72 may include, for example, a keyboard, a mouse, a joystick, a display, a touch screen, a microphone, a speaker, or other input/output mechanisms.

The processor 70 may comprise user interface circuitry configured to control at least some functions of one or more elements of the user interface 72, such as, for example, the speaker, the ringer, the microphone, the display, and/or the like. The processor 70 and/or user interface circuitry comprising the processor 70 may be configured to control one or more functions of one or more elements of the user interface 72 through computer program instructions (for example, software and/or firmware) stored on a memory accessible to the processor 70 (for example, memory device 76, and/or the like).

In some embodiments the apparatus 50 may comprise a registrar 78. The processor 70 may be embodied as, include or otherwise control the registrar 78. The registrar 78 may be configured to register one or more settings for requesting one or more content segments. The settings may be registered for a content channel configured to recommend the content segments and/or the settings may be registered for a content provider configured to provide the content segments. A content channel, as used herein, may refer to a source or collection of content segments that relate to one or more topics. Thus, the settings may be applicable to one or more content providers individually, or the settings may be applicable to all of the content providers providing content through a content channel.

The content segments may be provided by one or more content providers 35 and recommended by one or more content recommenders 40, as described above. By way of example, content channels may provide content segments relating to sports, news, nearby restaurants, nearby events, etc. in one or more of various types of media formats. However, one or more content channels may be generic, and thus the channel may provide random content segments. In some embodiments the content channels may output content segments on the user terminal 10 in the form of URLs that the user may select, although the content segments may be outputted in other forms in other embodiments as noted above. Thus, the user may be provided with a plurality of content channels for selection. Thereby the user may select one or more of the content channels, for example through use of the user interface 72 and a channel invoker to receive content segments associated therewith.

As noted above, the registrar 78 may register settings for requesting content segments. As further noted above, the settings may relate to a particular content provider, or more generally to a content channel that may provide content segments from one or more content providers. Settings, as used herein, may refer to information that dictates what and how information is included in requests for content segments, and when the requests occur. Thus, settings differ from user profile information that may be used by the content providers 35 and/or content recommender 40 to select content for recommendation.

By way of example, settings may include update settings. Update settings may define instances in which new content segments are requested. Settings may also include one or more operational settings. Operational settings may define what information (e.g., heuristics) is included in a request for content segments and how the information is included in the request. For example, operational settings may define what contextual data, user data, application data, and/or device data should be collected and included in the request. The update settings may be stored in an update settings registry and the operational settings may be stored in an operational settings registry in some embodiments. Further, the update settings registry and/or the operational settings registry may be maintained in the memory device 76 in some embodiments.

The registrar 78 may also register various other settings. For example, the settings may also include channel content information (if a new content channel is being registered), content information (for adding a content provider 35 to a content channel), and URL information for the content channel or content segments. However, if no URL information is provided, a default service URL may be used to access the content channel and content segments. Thus, the registrar 78 may register one or more settings including settings for requesting content segments.

In some embodiments the apparatus 50 may further comprise a contextual characteristic determiner 80. The processor 70 may be embodied as, include or otherwise control the contextual characteristic determiner 80. The contextual characteristic determiner 80 may be configured to determine one or more contextual characteristics. Contextual characteristics, as used herein, refer to the context of the user of the apparatus 50 and/or the apparatus itself, and thus contextual characteristics may include the present time, location, activity, etcetera of the user and/or the apparatus. Accordingly, for example, the contextual characteristic determiner 80 may determine that the user is presently at home or outside and moving. In one embodiment the contextual characteristic determiner 80 may be configured to determine a mode of transportation. For example, in one embodiment the contextual characteristic determiner 80 may categorize the mode of transportation into a walking mode, or non-walking mode. By way of further example, non-walking modes may be associated with biking, driving, riding a train, etc. The mode of transportation may, for example, be determined based on the location and/or speed of the user and apparatus 50. Information relating to the location and speed of the user may, for example, be provided by a GPS module, though location and speed information may additionally or alternatively be provided through other means such as triangulation using cell phone towers in some embodiments. Thus, the apparatus 50 may determine one or more contextual characteristics.

In some embodiments the apparatus 50 may further comprise a settings manager 82. The processor 70 may be embodied as, include or otherwise control the settings manager 82. The settings manager 82 may be configured to adapt the settings based on the contextual characteristics. In this regard, the contextual characteristic determiner 80 may determine the contextual characteristics of the user and/or the apparatus 50 as described above, and the settings manager 82 may adapt the settings based thereon. In this regard, the settings manager 82 may dynamically adapt the settings based on the determined contextual characteristics. In some embodiments the settings manager 82 may be configured to prompt the contextual characteristic determiner 80 to determine specified contextual characteristics at specified times and/or locations based on the content channel selected by the user. For example, the settings manager 82 may select listeners for specified contextual characteristics relevant to the settings of the content channel selected by the user. Thereby, battery, processor, bandwidth, and/or sensor usage may be decreased because only that information which is relevant to the content channel based on the present activities of the user may be detected and provided to the content recommender 40 and/or the content providers 35.

For example, as noted above, the contextual characteristic determiner 80 may be configured to determine a mode of transportation of the user and apparatus 50. The settings manager 82 may be configured to adapt the settings based on the determined mode of transportation. Thus, for example, in an instance in which the mode of transportation is determined to be a walking mode, the settings manager 82 may be configured to adapt one or more settings based thereon. In one embodiment the settings manager 82 may be configured to adapt the update settings based on a spatial interval in an instance in which the mode of transportation is a walking mode. In this regard, the update settings may specify that the content segments should be updated after the user and apparatus 50 travel a specified distance. For example, the update settings may specify that the content segments should be updated every time the user travels twenty meters. However, various other spatial intervals may be employed in other embodiments.

By way of further example, the settings manager 82 may be configured to adapt the update settings based on a temporal interval in an instance in which the mode of transportation is a non-walking mode. In this regard, the update settings may specify that the content segments should be updated after a specified period of time. For example, the update settings may specify that the content segments should be updated every thirty minutes. However, various other temporal intervals may be employed in other embodiments.

As noted above, the settings manager 82 may also be configured to adapt other settings beyond the update settings. For example, the settings manager 82 may additionally or alternatively be configured to adapt the operational settings included in a content request package. In this regard, for example, the settings manager 82 may adapt the operational settings such that if the contextual characteristic determiner 80 determines that the time of year is winter and the user is located near mountains, the operational characteristics may include information specifying whether or not the user has installed applications on the apparatus 50 relating to skiing.

Conversely, the settings manager 82 may adapt the operational settings such that if the contextual characteristic determiner 80 determines that the time of year is summer and the user is located near a body of water, the operational characteristics may include information specifying whether or not the user has installed applications on the apparatus 50 relating to warmer weather activities, such as boating. Thereby, the settings manager 82 may additionally or alternatively adapt the operational settings included in the content request package such that the information provided to the content providers 35 and/or the content recommender 40 is relevant to the user's context.

The settings manager 82 may adapt the settings through use of Extensible Markup Language (XML) in some embodiments. However the settings may be adapted through use of various other languages or methods in other embodiments. One example settings description configured to adapt settings for requesting content segments from content channels named “xx” and “xxy” is shown below. This example illustrates instructions for adapting update settings for content channel xx based on the determined mode of transportation, as discussed above:

```
  <Settings>
<default content channels=“*”> //describes default behavior
of the apparatus - configurable behavior
    <noRequestConditions>
      <tokens>displayOff, clientOff, idleState</tokens>
    </noRequestConditions>
</default>
<content channel name=“xx” id=“1234”>
    <rule id=“1”>
      <trigger>
      <contextual characteristic =“mode of transportation”
      value=“walking mode”>
      </trigger>
      <settingType>
        <type>spatial interval</type>
        <value unit=“kilometers”>0.02</value>
      </settingType>
    </rule>
    <rule id=“2”>
      <trigger>
      <contextual characteristic=“mode of transportation”
      value=“non-walking mode”>
      </trigger>
      <settingType>
        <type>temporal interval</type>
        <value unit=“minutes”>30<value>
      </settingType>
    </rule>
    <rule id=“3” type=“default”>
      <settingType>
        <type>temporal</type>
        <value unit=“minutes”>20</value>
      </settingType>
    </rule>
</content channel>
<content channel name=“xxy” id=“1235”>
    <rule id=“4”>
    <trigger>
    </trigger>
    </rule>
    <rule id=“5”>
    <trigger>
    </trigger>
    </rule>
</content channel>
........
</Settings>
```

In the code shown above the content channel name may refer to the content channel, whereas the “id” may refer to the content provider associated with the content channel. Further, the identifier “RequestConditions,” as shown above, may be used to describe the general conditions under which request for content segments may be sent. The tokens and their behavior may be inbuilt into the apparatus 50, and the apparatus may interpret the tokens based on an underlying platform. The example shown above within RequestConditions is for the negated case where by default no content request packages must be sent. The RequestConditions section also shows that the conditions are applicable for all channels. Similarly, default conditions can also be specified for each channel. The default conditions may be inserted directly by the original equipment manufacturer. Thus, the above-described code indicates the conditions under which content segments are requested via use of tokens specifying the conditions (in terms of contextual characteristics). This behavior may take precedence over all settings of the content channel and/or content providers associated therewith.

The settings manager 82 has been generally described above as being configured to adapt both the update settings and the operational settings. However, in other embodiments the apparatus 50 may additionally or alternatively comprise an update settings module and/or an operational settings module configured to adapt the update settings and the operational settings, respectively. For example, the update settings module may parse and validate update settings provided during the registration processes and insert unique identifiers within the context of the content delivery application. Thus, the functions performed by the settings manager 82 may be dispersed among other modules in some embodiments.

In some embodiments the apparatus 50 may further comprise a content requestor 84. The processor 70 may be embodied as, include or otherwise control the content requestor 84. The content requestor 84 may be configured to build a content request package based on the above-described settings. In one embodiment the content request package may be sent to the content recommender 40 and/or the content recommenders 35 via Hypertext Transmission Protocol (HTTP).

The update settings may specify when the content requestor 84 builds content request packages. For example, the content requestor 84 may build new content request packages after the passage of a temporal or spatial interval as specified by the settings manager 82. Further, the operational settings may describe what data and information the content requestor 84 includes in the content request package. For example, the settings manager 82 may specify what application information should be included in the content request package. The content requestor 84 may also include other information and data in the content request package in some embodiments. For example, the content requestor 84 may include an authentication token in the content request package that may allow the content recommender 40 to identify a user profile associated with the apparatus 50 and thereby the recommendation of content segments by the content providers 35 and/or the content recommender may be based in part on the user profile in addition to the contextual characteristics and other information included in the content request package in some embodiments.

The content requestor 84 may thereby provide for transmission of the content request package. For example the content request package may be sent through the communication interface 74 to the content recommender 40, which may then recommend content segments provided by one or more of the content providers 35.

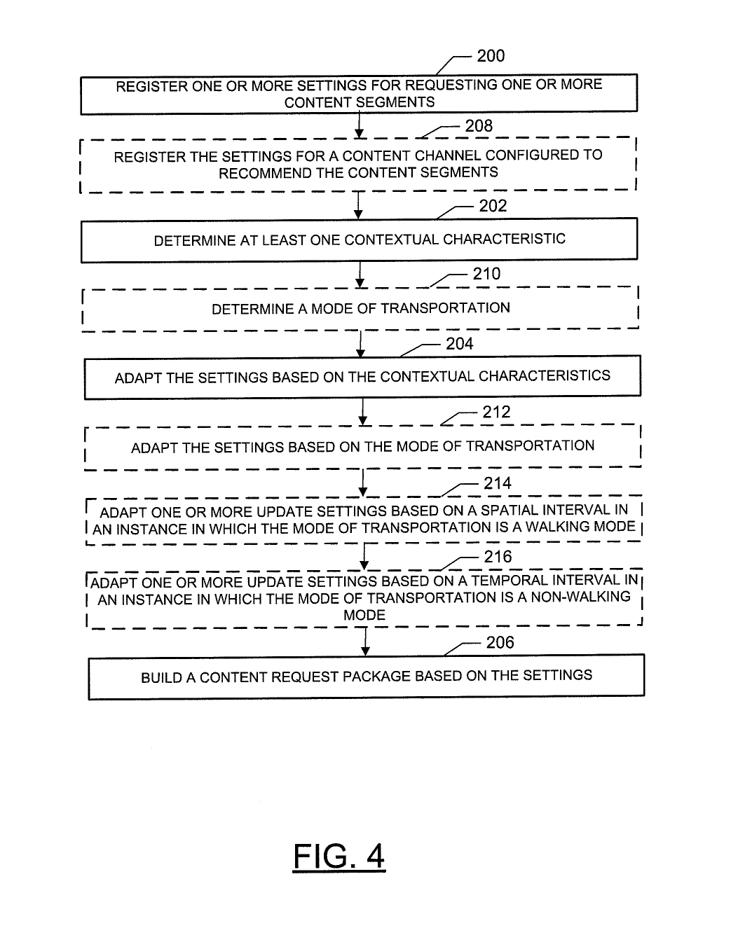

In terms of methods associated with embodiments of the present invention, the above-described apparatus 50 or other embodiments of apparatuses may be employed. In this regard, FIG. 4 is a flowchart of a system, method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by a computer program product including computer program instructions. In this regard, the computer program instructions which embody the procedures described above may be stored by a memory device and executed by a processor of an apparatus. As will be appreciated, any such computer program instructions may be loaded onto a computer or other programmable apparatus (for example, hardware) to produce a machine, such that the resulting computer or other programmable apparatus embody means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In this regard, one embodiment of a method may include registering one or more settings for requesting one or more content segments at operation 200. In some embodiments the settings may comprise one or more update settings and/or one or more operational settings. Further, the method may include determining at least one contextual characteristic at operation 202. Also, the method may comprise adapting the settings based on the contextual characteristic at operation 204. Additionally, the method may include building a content request package based on the settings 206.

In some embodiments, certain ones of the above-described operations (as illustrated in solid lines in FIG. 4) may be modified or further amplified. In some embodiments additional operations may also be included (some examples of which are shown in dashed lines in FIG. 4). It should be appreciated that each of the modifications, optional additions or amplifications may be included with the above-described operations (200-206) either alone or in combination with any others among the features described herein. As such, each of the other operations as will be described herein may be combinable with the above-described operations (200-206) either alone or with one, more than one, or all of the additional operations in any combination.

For example, registering the settings at operation 200 may comprise registering the settings for a content channel configured to recommend the content segments at operation 208. Further, determining the contextual characteristic at operation 202 may comprise determining a mode of transportation at operation 210. Additionally, adapting the settings at operation 204 may comprise adapting the settings based on the mode of transportation at operation 212. For example, adapting the settings based on the mode of transportation at operation 212 may include adapting one or more update settings based on a spatial interval in an instance in which the mode of transportation is a walking mode at operation 214. By way of further example, adapting the settings based on the mode of transportation at operation 212 may comprise adapting one or more update settings based on a temporal interval in an instance in which the mode of transportation is a non-walking mode at operation 216.

In an example embodiment, an apparatus for performing the method of FIG. 4 and other methods described above may comprise a processor (for example, the processor 70) configured to perform some or each of the operations (200-216) described above. The processor may, for example, be configured to perform the operations (200-216) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 200-216 may comprise, for example, the processor 70, the user interface 72, the communication interface 74, the registrar 78, the contextual characteristic determiner 80, the settings manager 82, and the content requestor 84, as described above. However, the above-described portions of the apparatus 50 as they relate to the operations of the method illustrated in FIG. 4 are merely examples, and it should be understood that various other embodiments may be possible.

In some embodiments the operation 200 of registering one or more settings for requesting one or more content segments may be conducted by means, such as the registrar 78, the user interface 72, the communication interface 74, the settings manager 84, and/or the processor 70. Additionally, the operation 202 of determining at least one contextual characteristic may be conducted by means, such as the contextual characteristic determiner 84, and/or the processor 70. Also, the operation 204 of adapting the settings based on the contextual characteristic may be conducted by means, such as the settings manager 82, and/or the processor 70. Further, building a content request package based on the settings at operation 206 may be conducted by means, such as the content requestor 84, the settings manager 82, the communication interface 74, and/or the processor 70.

Additionally, the operation 208 of registering the settings for a content channel configured to recommend the content segments may be conducted by means, such as the registrar 78, the user interface 72, the communication interface 74, the settings manager 84, and/or the processor 70. Additionally, the operation 210 of determining a mode of transportation may be conducted by means, such as the contextual characteristic determiner 84, and/or the processor 70. Also, the operation 212 of adapting the settings based on the mode of transportation, the operation 214 of adapting one or more update settings based on a spatial interval in an instance in which the mode of transportation is a walking mode, and/or the operation 216 of adapting one or more update settings based on a temporal interval in an instance in which the mode of transportation is a non-walking mode may be conducted by means, such as settings manager 82, and/or the processor 70.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. An apparatus comprising at least one processor and at least one memory including computer program code, the at least one memory and the computer program code configured to, with the processor, cause the apparatus to:
register one or more settings for requesting one or more content segments;
determine at least one contextual characteristic;
adapt the settings based on the contextual characteristic; and
build a content request package based on the settings.

2. The apparatus of claim 1, wherein the settings comprise one or more update settings.

3. The apparatus of claim 1, wherein the settings comprise one or more operational settings.

4. The apparatus of claim 1, further configured to determine a mode of transportation; and
adapt the settings based on the mode of transportation.

5. The apparatus of claim 4, further configured to adapt one or more update settings based on a spatial interval in an instance in which the mode of transportation is a walking mode.

6. The apparatus of claim 4, further configured to adapt one or more update settings based on a temporal interval in an instance in which the mode of transportation is a non-walking mode.

7. The apparatus of claim 1, further comprising user interface circuitry configured to:
facilitate user control of at least some functions of the apparatus through use of a display; and
cause at least a portion of a user interface of the apparatus to be displayed on the display to facilitate user control of at least some functions of the apparatus.

8. A method, comprising:
registering one or more settings for requesting one or more content segments;
determining at least one contextual characteristic;
adapting the settings via a processor based on the contextual characteristic; and
building a content request package based on the settings.

9. The method of claim 8, wherein the settings comprise one or more update settings.

10. The method of claim 8, wherein the settings comprise one or more operational settings.

11. The method of claim 8, further comprising determining a mode of transportation; and
adapting the settings based on the mode of transportation.

12. The method of claim 11, further comprising adapting one or more update settings based on a spatial interval in an instance in which the mode of transportation is a walking mode.

13. The method of claim 11, further comprising adapting one or more update settings based on a temporal interval in an instance in which the mode of transportation is a non-walking mode.

14. The method of claim 8, further comprising registering the settings for a content channel configured to recommend the content segments.

15. A computer program product comprising at least one computer-readable storage medium having computer-executable program code portions stored therein, the computer-executable program code portions comprising:
program code instructions for registering one or more settings for requesting one or more content segments;
program code instructions for determining at least one contextual characteristic;
program code instructions for adapting the settings based on the contextual characteristic; and
program code instructions for building a content request package based on the settings.

16. The computer program product of claim 15, wherein the settings comprise one or more update settings.

17. The computer program product of claim 15, wherein the settings comprise one or more operational settings.

18. The computer program product of claim 15, further comprising program code instructions for determining a mode of transportation; and
program code instructions for adapting the settings based on the mode of transportation.

19. The computer program product of claim 18, further comprising program code instructions for adapting one or more update settings based on a spatial interval in an instance in which the mode of transportation is a walking mode.

20. The computer program product of claim 18, further comprising program code instructions for adapting one or more update settings based on a temporal interval in an instance in which the mode of transportation is a non-walking mode.
